(19) United States
(12) Patent Application Publication
(10) Pub. No.: US 2026/0165530 A1
(43) Pub. Date: Jun. 18, 2026

(54) Baking Tray Protective Plate

(71) Applicant: Zhejiang Shuaishuai TECHNOLOGIES Co., Ltd., Zhejiang (CN)

(72) Inventor: Guojing CHEN, Zhejiang (CN)

(73) Assignee: Zhejiang Shuaishuai TECHNOLOGIES Co., Ltd., Zhejiang (CN)

(21) Appl. No.: 19/382,129

(22) Filed: Nov. 6, 2025

(51) Int. Cl. A47J 37/06; H05B 3/68

(52) U.S. Cl. CPC A47J 37/0676; H05B 3/68

(57) ABSTRACT

The present disclosure relates to a baking tray protective plate, comprising: a baking tray assembly, provided with a clamping slot on the baking tray assembly; and a baffle assembly, including an oil baffle plate and a buckle, the buckle being arranged on the oil baffle plate, with limiting grooves formed on both sides of the oil baffle plate. The oil baffle plate is made of a flexible material, and the buckle is inserted into the clamping slot to achieve detachable installation of the baffle assembly.

### TECHNICAL FIELD

The present disclosure relates to the technical field of baking trays, particularly to a baking tray protective plate.

### BACKGROUND

During the use of baking trays, there is a risk of operators being scalded due to splattering cooking oil, necessitating specialized oil baffle products to address this safety hazard. However, most existing oil baffle products for baking trays are made of stainless steel hardware, which has significant drawbacks: on one hand, the sharp edges of stainless steel hardware can easily cut the hands of operators during installation, posing a safety risk; on the other hand, the high thermal conductivity of stainless steel causes the metal oil baffle plate to quickly heat up to high temperatures during baking tray use. If operators accidentally come into contact with the oil baffle plate during use, scalding accidents are likely to occur, failing to effectively ensure safety during use and making it difficult to meet users'demands for safe and convenient oil baffle products.

Taking U.S. Pat. No. 11,800,954B2 as an example, it discloses an outdoor cooking station with a splash guard design. The system attempts to address the issue of grease splattering through the coordination of the splash guard and an oil collection tray. Although this design improves grease management, its oil baffle wall remains a fixed metal structure. Contact with its high-temperature surface during use can still cause scalding, failing to fundamentally enhance safety and user-friendly experience.

### SUMMARY

The present disclosure provides a baking tray protective plate to solve the problems raised in the background art.

To achieve the above object, the present disclosure adopts the following technical solutions:

A baking tray protective plate comprises a baking tray assembly provided with a clamping slot; and a baffle assembly, comprising an oil baffle plate and a buckle, the buckle being arranged on the oil baffle plate, with limiting grooves formed on both sides of the oil baffle plate. The oil baffle plate is made of a flexible material, and the buckle is inserted into the clamping slot to achieve detachable installation of the baffle assembly.

A baking tray protective plate comprises a baking tray assembly, comprising a base and a baking tray, the baking tray being arranged on the base, with a clamping slot provided on the base; and a baffle assembly, comprising an oil baffle plate and a buckle, the oil baffle plate being U-shaped, the buckle being arranged on the oil baffle plate, and limiting grooves being provided on both sides of the oil baffle plate. The oil baffle plate is made of a flexible material, and the buckle is inserted into the clamping slot to achieve detachable installation of the baffle assembly.

The beneficial effects of the present disclosure compared to the prior art are as follows:

The snap-fit design between the baffle assembly and the base facilitates the disassembly and cleaning of the oil baffle plate, which effectively prevents oil splashing and scalding. The clearance design between the oil baffle plate and the baking tray avoids damage to the oil baffle plate due to prolonged high temperatures. The cooperation between the oil receiving tray and the oil drain port effectively collects grease and prevents grease splashing. The heating tube is protected by the baking tray and the connecting shell, enhancing safety. The overall structure is simple, user-friendly, and highly protective.

### BRIEF DESCRIPTION OF DRAWINGS

The drawings, which form part of this application, are included to provide a further understanding of the present disclosure. The illustrative embodiments of the present disclosure and the descriptions thereof are intended to explain the present disclosure and do not constitute any undue limitation thereof. In the drawings:

FIG. 1 is a perspective schematic view of an embodiment provided by the present disclosure.

FIG. 2 is a structural schematic view of the baffle assembly in the embodiment of FIG. 1.

FIG. 3 is a top structural schematic view of the base and baking tray in the embodiment shown in FIG. 1.

FIG. 4 is a top structural schematic view of the clamping slot, heater, and heating tube in the embodiment shown in FIG. 3.

FIG. 5 is a perspective schematic view of the first connecting block and the second connecting block in the embodiment shown in FIG. 1.

FIG. 6 is a schematic view of the baking tray from another perspective in the embodiment shown in FIG. 1.

Reference signs: Base (100); Clamping Slot (101); Connecting Seat (102); Oil Receiving Tray (103); First Connecting Block (104); Baking Tray (200); Oil Drain Port (201); Connecting Shell (202); Connecting Groove (203); Second Connecting Block (204); Baffle Assembly (300); Oil Baffle Plate (301); Buckle (302); Limiting Groove (303); Controller (400); Handle (500); Heater (600); Heating Tube (601).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

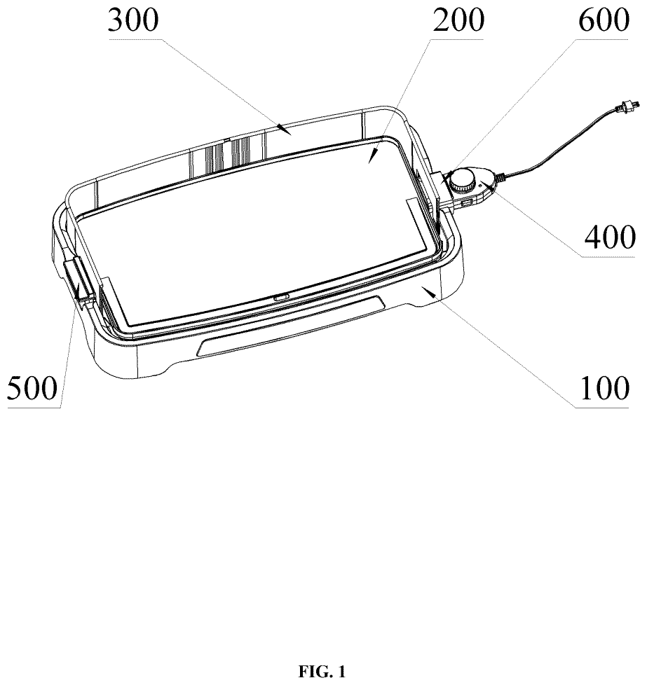

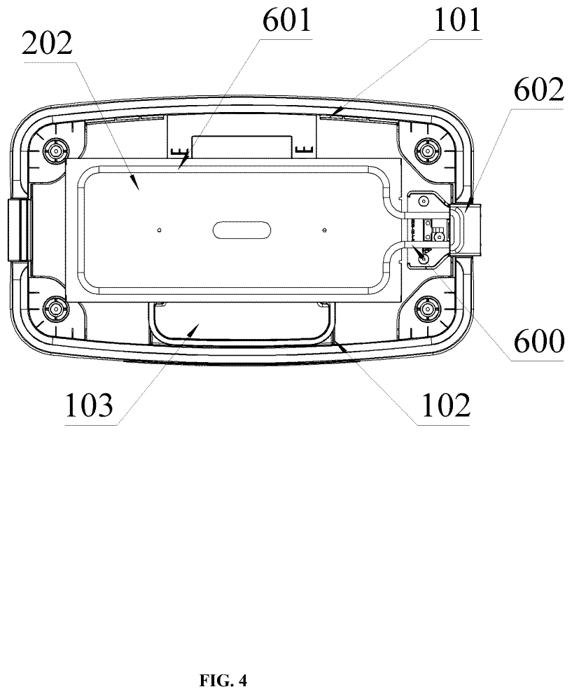

As shown in FIGS. 1 to 6, a baking tray protective plate includes a base 100, a baking tray 200, and a baffle assembly 300. The baking tray 200 is placed on the base 100, which is made of high-temperature-resistant metal material (such as stainless steel or aluminum alloy), while the baking tray 200 is made of a cast iron or ceramic-coated material. The base 100 is provided with a plurality of clamping slots 101, which are evenly distributed along the inner wall of the base 100. The baffle assembly 300 is engaged with the clamping slots 101, enabling detachable installation. The left and right ends of the base 100 are equipped with a handle 500 and a heater 600 respectively, both made of heat-insulating material for easy movement of the device by gripping the handle 500 and heater 600. Inside the base 100, a loop-shaped heating tube 601 is installed, with both ends connected to the heater 600. The heater 600 houses a controller 400, which is a programmable thermostat. The controller 400 is powered via a power cord, allowing users to adjust the heating temperature of the heating tube 601 through the controller 400, thereby heating the tube to a set temperature (e.g., 150° C. to 250° C.) and evenly transferring heat to the baking tray 200 for uniform food heating.

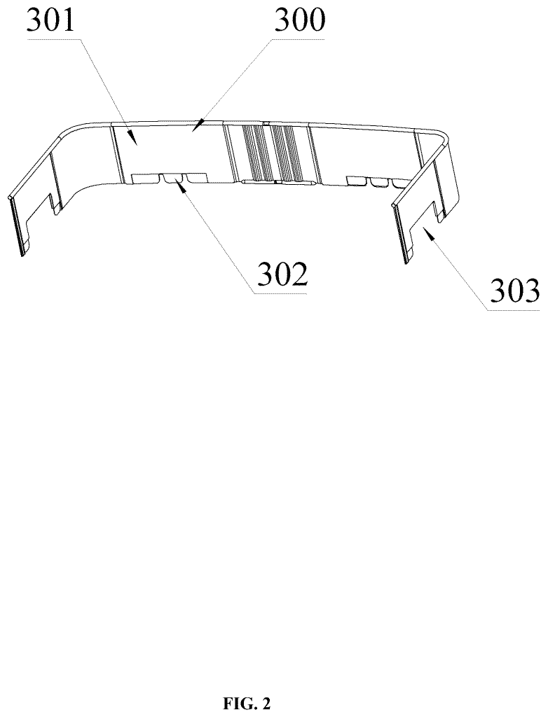

As shown in FIGS. 1 and 2, the baffle assembly 300 includes an oil baffle plate 301 and a buckle 302. The oil baffle plate 301 is U-shaped, and the buckle 302 is installed on the oil baffle plate 301. The buckle 302 is made of stainless steel or spring steel, allowing it to be firmly inserted into the clamping slot 101, ensuring stable installation of the oil baffle plate 301 to the base 100. The buckle 302, made of metal, securely mounts the oil baffle plate 301 to the base 100. The oil baffle plate 301 is made of a soft material, such as silicone or TPU, which maintains shape stability at high temperatures. Its surface does not heat up due to the baking tray 200 warming, effectively preventing accidental contact by users and avoiding burns, thereby ensuring safety during use. There is a certain clearance between the oil baffle plate 301 and the baking tray 200, preventing damage to the oil baffle plate 301 caused by excessive temperature of the baking tray 200. Both ends of the oil baffle plate 301 are equipped with limiting grooves 303, whose shape matches the external contours of the handle 500 and the heater 600, preventing the baffle assembly 300 from interfering with the use of the handle 500 and the heater 600.

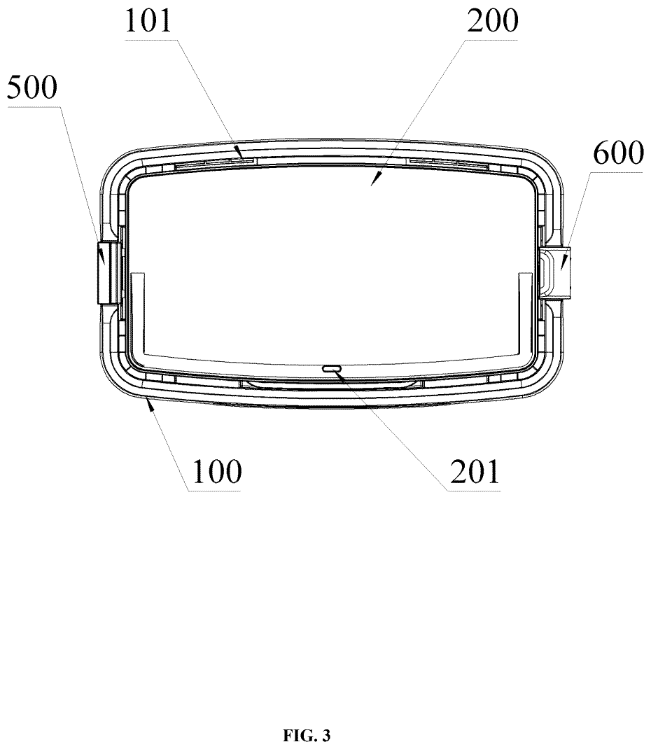

As shown in FIGS. 3 to 5, the inner wall of the base 100 is provided with a connecting seat 102, on which an oil receiving tray 103 is horizontally installed. The oil receiving tray 103 is made of stainless steel or high-temperature-resistant plastic and can be slidably detached along the connecting seat 102. The bottom of the baking tray 200 is equipped with an oil drain port 201, located above the oil receiving tray 103. During the use of the baking tray 200, excess grease flows through the oil drain port 201 into the oil receiving tray 103, preventing grease accumulation and splashing on the baking tray 200, further enhancing safety protection.

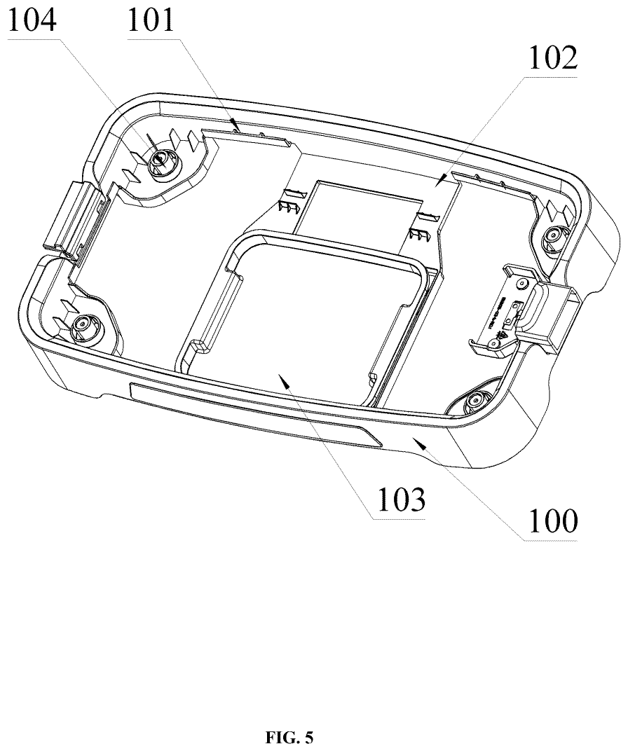

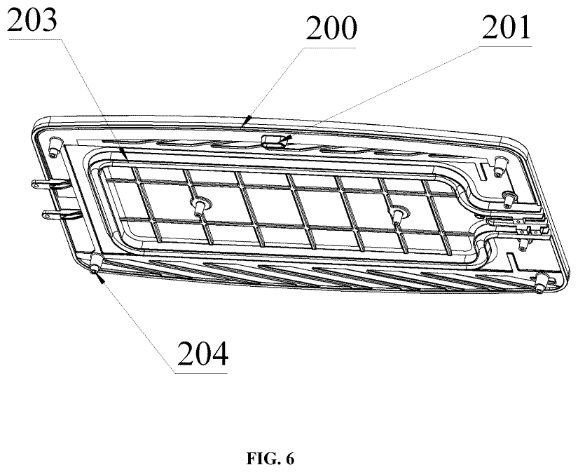

As shown in FIGS. 5 and 6, the inner bottom wall of the base 100 is surrounded by first connecting blocks 104, which are protrusion structures. The bottom of the baking tray 200 is surrounded by second connecting blocks 204, which are recess structures. By engaging the first connecting blocks 104 with the second connecting blocks 204, the baking tray 200 is supported and fixed, ensuring it remains stable and does not shift during heating.

As shown in FIGS. 5 and 6, the bottom of the baking tray 200 is provided with a connecting groove 203, which is an annular recess adapted to the loop shape of the heating tube 601, allowing the heating tube 601 to be embedded within the connecting groove 203. The bottom of the baking tray 200 is equipped with a connecting shell 202, made of thin metal sheets, forming an enclosed space with the bottom of the baking tray 200, where the heating tube 601 is located. This design effectively isolates grease and dust, preventing contamination or short circuits in the heating tube 601, thereby improving heating efficiency and safety performance.

In other embodiments (not shown), the buckle 302 of the baffle assembly 300 can be implemented in alternative ways. For example, the buckle 302 may be a magnetic structure made of permanent magnets, with corresponding iron materials embedded in the clamping slot 101, enabling quick installation and removal of the oil baffle plate 301 through a magnetic force. Alternatively, the buckle 302 may be a rotary knob structure that locks into the clamping slot 101 by rotation. The material of the oil baffle plate 301 can be extended to fluororubber or glass-fiber-reinforced plastic to withstand higher temperatures, such as above 300° C. The clearance between the oil baffle plate 301 and the baking tray 200 can be adjusted to 2-5 mm, with the gap size regulated by adding heat-resistant spacers on the inner side of the oil baffle plate 301. The shape of the limiting groove 303 can be expanded to L-shaped or trapezoidal to accommodate different forms of the handle 500 and heater 600.

In other embodiments (not shown), the oil receiving tray 103 can be designed as a drawer structure connected to the connecting seat 102 through sliding rails, allowing users to easily pull it out for cleaning. The oil drain port 201 can be fitted with a filter screen made of stainless steel wire to prevent food debris from entering the oil receiving tray 103. The material of the oil receiving tray 103 can be extended to ceramic or enamel for easier cleaning and corrosion resistance. Additionally, the oil receiving tray 103 can be equipped with a liquid level sensor that sends an alert signal through the controller 400 when the grease is full.

In other embodiments (not shown), the shape of the heating tube 601 is not limited to a loop and can be modified to spiral, serpentine, or grid patterns to optimize heat distribution. The material of the heating tube 601 can be extended to carbon fiber or infrared quartz tubes to enhance heating speed and energy efficiency. The connecting shell 202 can be fitted with ventilation holes to promote airflow while protecting the heating tube 601, preventing overheating. The depth of the connecting groove 203 can be adjusted to accommodate heating tubes 601 of different diameters.

In other embodiments (not shown), the plug-in connection between the first connecting block 104 and the second connecting block 204 can be replaced with a sliding rail connection. Specifically, a sliding rail is installed on the base 100, and a corresponding slider is placed at the bottom of the baking tray 200, allowing the baking tray 200 to be installed or removed by sliding. Alternatively, a magnetic connection can be used, where magnets are embedded in the first connecting block 104 and the second connecting block 204, securing them through a magnetic force. Additionally, the connecting blocks can be equipped with a locking mechanism, such as a spring pin, to ensure the baking tray 200 remains stable in vibrating environments.

In other embodiments (not shown), the controller 400 can be upgraded to a touchscreen smart controller featuring a 7-inch IPS touchscreen. Beyond basic temperature adjustment (adjustable from 100° C. to 300° C.), it adds three core functions: First, a timer function (precise timing from 0 to 120 minutes, with automatic power-off and a buzzer alert when the countdown ends); second, heating mode selection (with four preset modes: baking, grilling, defrosting, and warming, allowing users to customize and save mode parameters); and third, a self-diagnosis function (detecting faults such as heating tube 601 short circuits or temperature sensor abnormalities, with alerts through pop-up screens and indicator lights). The power supply breaks free from wired limitations by adopting electromagnetic induction wireless charging: the base 100 includes a built-in 100 mm-diameter wireless receiving coil (made of copper wire with 50 turns), paired with a dedicated wireless charging base (output power of 1500 W), enabling contactless power supply and eliminating cable tangles that hinder device mobility. Additionally, the controller 400 has a built-in 2000 mAh lithium battery, maintaining screen display and parameter memory for 30 minutes after power loss, enhancing convenience.

In other embodiments (not shown), the heat insulation and storage features of the handle 500 are further optimized. The insulation layer uses aerogel composite material, improving heat resistance by 40% compared to the original insulation, ensuring the outer surface temperature of the handle 500 remains ≤40° C. even when the base 100 operates at high temperatures. The outer surface of the handle 500 is textured with diamond-shaped anti-slip patterns to enhance grip friction and prevent slipping. Moreover, the handle 500 is designed as a foldable structure: connected to the base 100 through a 304 stainless steel hinge, which allows 0°-90° rotation. When in use, the handle 500 unfolds to 90° (locked in place by a spring positioning pin), and when not in use, it folds flush against the side wall of the base 100, reducing the device's horizontal storage size by 20% and saving storage space.

In other embodiments (not shown), the connection between the baking tray 200 and the base 100 adopts an elastic buckle structure, replacing the original plug-in fit: four spring buckles (made of 65Mn spring steel, with an elastic deformation range of 0-8 mm and zinc-plated for rust prevention) are symmetrically arranged on the inner wall of the base 100, each buckle top features an arc-shaped guiding surface; correspondingly, four arc-shaped buckle slots are opened at the bottom of the baking tray 200. When the baking tray 200 is pressed, the buckles retract along the guiding surface and automatically snap into the slots, achieving quick fixation; to remove, press the unlock button on the outer side of the buckle to release it and take out the baking tray 200, eliminating the need for tools and enhancing convenience. Meanwhile, the baking tray 200 adopts a double-layer detachable structure: the outer layer is made of cast iron, while the inner layer is a food-grade 304 stainless steel liner coated with PTFE non-stick coating (temperature-resistant up to 260° C.). Users can replace the liner according to cooking needs (e.g., switching to a ceramic liner for baking cakes or a stainless steel liner for grilling meat), and the liner can be detached separately for cleaning, avoiding the cumbersome issue of cleaning the entire baking tray 200.

In other embodiments (not shown), the heating tube 601 adopts a zonal design, breaking through the single loop structure: the heating area is divided into three independent units—inner ring, middle ring, and outer ring, each corresponding to a set of carbon fiber heating tubes (single set power 500 W, heating speed 30% faster than traditional metal tubes). The three sets of heating tubes 601 are connected to the controller 400 via independent circuits, allowing users to adjust the temperature of each zone separately (e.g., 200° C. in the inner ring for steak, 180° C. in the middle ring for vegetables, and 160° C. in the outer ring for keeping bread warm), catering to the need for simultaneous multi-ingredient cooking. To reduce heat loss, glass fiber insulation cotton is pasted on the inner side of the connecting shell 202 to prevent heat from spreading to the base 100; the outer side of the heating tube 601 is wrapped with an aluminum foil reflective layer to direct heat toward the bottom of the baking tray 200, improving thermal efficiency by 15%. Additionally, the ventilation holes on the connecting shell 202 are redesigned into a louvered structure, ensuring air circulation for heat dissipation while blocking grease splashes from entering the heating tube area.

In other embodiments (not shown), an NTC temperature sensor is installed beside the heating tube 601. When the temperature of the heating tube 601 exceeds 300° C., the controller 400 automatically cuts off the power to the heater 600 and triggers an alarm with a flashing red indicator light. The edges of the baking tray 200 are wrapped with food-grade silicone to prevent burns from accidental contact with the high-temperature edges when users handle the tray. The base 100 is equipped with four removable silicone anti-slip pads at the bottom to increase static friction with the table surface, preventing the device from sliding due to vibration during operation. A food-grade silicone seal is added to the connecting seat 102 on the inner wall of the base 100 to seal the gap between the oil receiving tray 103 and the connecting seat 102, avoiding oil leakage. The inner side of the oil receiving tray 103 is coated with a nano-hydrophobic layer, making it difficult for oil to adhere, so only rinsing with water is needed for cleaning. Additionally, the base 100 features a removable dust-proof mesh on the side, which can be periodically cleaned to prevent dust buildup from affecting the heat dissipation of the heating tube 601.

In summary, the present disclosure achieves the following technical effects:

The snap-fit design between the baffle assembly 300 and the base 100 enables removable installation of the oil baffle plate 301, facilitating disassembly and cleaning. The oil baffle plate 301 effectively prevents oil from splashing outward and causing burns. The clearance design between the oil baffle plate 301 and the baking tray 200 avoids damage to the oil baffle plate 301 from prolonged exposure to high temperatures. The cooperation between the oil receiving tray 103 and the oil drain port 201 efficiently collects oil, preventing splashing. The heating tube 601 is protected by the baking tray 200 and the connecting shell 202, enhancing safety. The overall structure is simple, user-friendly, and highly protective.

In the description of the present disclosure, it should be appreciated that directional terms such as “front, rear, up, down, left, right”, “horizontal, vertical, perpendicular, horizontal” and “top, bottom” etc. indicate the orientation or positional relationship based on the orientation or positional relationship shown in the drawings, and are only for the convenience of describing the present disclosure and simplifying the description. In the absence of a contrary explanation, these directional terms do not indicate or imply that the device or element referred to must have a specific orientation or be constructed and operated in a specific orientation, and therefore should not be understood as limiting the scope of protection of the present disclosure; the directional terms “inside, outside” refer to the inside and outside relative to the contour of each component itself.

For the convenience of description, spatial relative terms such as “on . . . ”, “above . . . ”, “on the upper surface of . . . ”, “upper” etc. may be used here to describe the spatial positional relationship of a device or feature with other devices or features as shown in the drawings. It should be appreciated that spatial relative terms are intended to encompass different orientations of the device in use or operation other than the orientation described in the drawings. For example, if the device in the drawing is inverted, the device described as “above other devices or structures” or “on other devices or structures” will subsequently be positioned as “below other devices or structures” or “under other devices or structures”. Thus, the exemplary term “above” can include both “above” and “below” orientations. The device can also be positioned in other different ways (rotated 90 degrees or in other orientations), and the spatial relative descriptions used here should be interpreted accordingly.

In addition, it should be noted that the use of terms such as “first”, “second” etc. to define components is for the convenience of distinguishing the corresponding components. Unless otherwise stated, the above terms have no special meaning, and therefore should not be understood as limiting the scope of protection of the present disclosure.

The above description is only a preferred embodiment of the present disclosure and is not intended to limit the present disclosure. For those skilled in the art, the present disclosure can have various modifications and changes. Any modifications, equivalent replacements, improvements etc. made within the spirit and principles of the present disclosure should be included within the scope of protection of the present disclosure.

What is claimed is:

1. A baking tray protective plate, comprising:
a baking tray assembly provided with a clamping slot; and
a baffle assembly, comprising an oil baffle plate and a buckle, the buckle being arranged on the oil baffle plate, with limiting grooves formed on both sides of the oil baffle plate;
wherein the oil baffle plate is made of a flexible material, and the buckle is inserted into the clamping slot to achieve detachable installation of the baffle assembly.

2. The baking tray protective plate according to claim 1, wherein the baking tray assembly comprises a base and a baking tray, the baking tray is arranged on the base, and the clamping slot is arranged on an inner side wall of the base.

3. The baking tray protective plate according to claim 1, wherein the oil baffle plate is U-shaped, there are a plurality of clamping slots, and the plurality of clamping slots are evenly distributed on the inner side wall of the base.

4. The baking tray protective plate according to claim 2, further comprising a handle and a heater, wherein the handle and the heater are arranged on the base, and a shape of the limiting groove is configured to match external contours of the handle and the heater.

5. The baking tray protective plate according to claim 2, wherein a connecting seat is provided on an inner wall of the base, and an oil receiving tray is detachably arranged on the connecting seat.

6. The baking tray protective plate according to claim 5, wherein an oil drain port is provided at a bottom of the baking tray, and the oil drain port is located above the oil receiving tray.

7. The baking tray protective plate according to claim 2, wherein a first connecting block is provided on an inner bottom wall of the base, a second connecting block is provided at the bottom of the baking tray, and the first connecting block and the second connecting block are engaged to fix the baking tray.

8. The baking tray protective plate according to claim 4, wherein a connecting groove is formed at the bottom of the baking tray, a heating tube is arranged inside the base, at least part of the heating tube is embedded in the connecting groove, and the heating tube is fixedly connected to the heater.

9. The baking tray protective plate according to claim 8, wherein the heating tube is in a rectangular spiral shape, a connecting shell is arranged at the bottom of the baking tray, and the connecting shell and the bottom of the baking tray enclose to form an enclosed space for accommodating the heating tube.

10. The baking tray protective plate according to claim 2, wherein a clearance is formed between the oil baffle plate and a side wall of the baking tray.

11. The baking tray protective plate according to claim 8, further comprising a controller, wherein the controller is inserted into an interior of the heater and configured to control the heater to adjust a temperature of the heating tube.

12. A baking tray protective plate, comprising:
a baking tray assembly, comprising a base and a baking tray, the baking tray being arranged on the base, with a clamping slot provided on the base; and
a baffle assembly, comprising an oil baffle plate and a buckle, the oil baffle plate being U-shaped, the buckle being arranged on the oil baffle plate, and limiting grooves being provided on both sides of the oil baffle plate;
wherein the oil baffle plate is made of a flexible material, and the buckle is inserted into the clamping slot to achieve detachable installation of the baffle assembly.

13. The baking tray protective plate according to claim 12, wherein a plurality of clamping slots are uniformly distributed on an inner wall of the base.

14. The baking tray protective plate according to claim 12, further comprising a handle and a heater, wherein the handle and the heater are arranged at two ends of the base respectively, and a shape of the limiting groove is configured to match external contours of the handle and the heater.

15. The baking tray protective plate according to claim 12, further comprising a connecting seat and an oil receiving tray, wherein the connecting seat are arranged on the inner wall of the base, the oil receiving tray is detachably arranged on the connecting seat, and the oil receiving tray is located below the baking tray.

16. The baking tray protective plate according to claim 15, further comprising an oil drain port, wherein the oil drain port is arranged at a bottom of the baking tray and located above the oil receiving tray.

17. The baking tray protective plate according to claim 12, further comprising a first connecting block and a second connecting block, wherein the first connecting block are arranged on an inner bottom wall of the base, and the second connecting block is arranged at the bottom of the baking tray; and the first connecting block is a protrusion structure, the second connecting block is a recess structure, and the first connecting block and the second connecting block are inserted and fitted to fix the base and the baking tray.

18. The baking tray protective plate according to claim 14, further comprising a heating tube, wherein a connecting groove is provided at the bottom of the baking tray, and the heating tube is arranged in the connecting groove.

19. The baking tray protective plate according to claim 18, wherein the heating tube is fixedly connected to the heater, the heating tube is in a rectangular spiral shape, a connecting shell is arranged at the bottom of the baking tray, and the connecting shell and the bottom of the baking tray enclose to form an enclosed space for accommodating the heating tube.

20. The baking tray protective plate according to claim 19, further comprising a controller, the controller is inserted inside the heater and configured to control the heater to adjust a temperature of the heating tube.
